(19) United States
(12) Patent Application Publication
(10) Pub. No.: US 2006/0081662 A1
(43) Pub. Date: Apr. 20, 2006

(54) Bottle spout

(75) Inventor: Noboru Miura, Ibaraki (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shuichi MIURA, Ibaraki (JP)

(21) Appl. No.: 10/545,086

(22) PCT Filed: Feb. 24, 2004
(86) PCT No.: PCT/JP04/02147

§ 371 Date: Aug. 9, 2005

(30) Foreign Application Priority Data
Feb. 25, 2003 (JP) 200398664
Apr. 8, 2003 (JP) 2003136595

(51) Int. Cl. B67D 3/00

(52) U.S. Cl. 222/481.5

(57) ABSTRACT

A spout (2) of a bottle (1) is provided on the inner side thereof with a partition (3) for dividing the space inside the spout into a liquid effluent part (5) and an air influent part (6). The partition is connected to and integrated with the spout. The space inside the spout divided by the partition is opened in the opening face of the spout toward the outer direction on both the liquid effluent part side and the air influent part side. The partition on the air influent part side is directed toward the interior of the bottle and continued to the inner wall of the spout and closed in the form of a bag. The partition is provided on the trailing part thereof with an air hole (4) connecting the air influent part and the interior of the bottle. When a person applies his lips to the liquid effluent part and tilts the bottle so as to lower the liquid effluent part, the drinking water in the bottle flows into his mouth through the liquid effluent part. As a result, the pressure inside the bottle is lowered and the air is caused to flow into the bottle via the air hole in the air influent part. Since the drinking water flowing out of the bottle and the air flowing into the bottle do not collide, the drinking water is smoothly and continuously poured into the mouth.

### TECHNICAL FIELD

This invention relates to a bottle spout. More particularly this invention relates to a spout of a bottle or other such container, which permits comfortable swallow or smooth pour of the liquid held therein.

### BACKGROUND ART

When a person directly applies his mouth to the spout of a bottle containing drinking water or a refreshing beverage and swallows the drink, the drink flowing out of the bottle and the air flowing into the bottle collide in the neighborhood of the spout and compel the drink to produce an undulating motion. The undulating drink possibly chokes the person swallowing the drink or scatters in the surrounding environment. When a person riding on a vehicle in motion and feeling the need for a drink directly from a bottle attempts to put his mouth to part of the spout of the bottle instead of wrapping his mouth wholly around the top of the bottle, the drink inside the bottle possibly jumps up and down and spills.

With the object of preventing the drink in a bottle from emitting a swirling motion during the course of release from the bottle, JP-A HEI 10-119974 proposes a spouting aid which is constructed by forming a partition adapted to divide the spout of a bottle for a drink and directed toward the interior of the bottle and concealing one of the divided parts of the spout with a covering part provided with a ventilating hole so as to prevent the drink from producing a swirling motion and flowing out on the ventilating hole side.

When a person desiring to take the drink from the bottle that is furnished with this spouting aid applies his mouth to the opening part of the spout, he encounters difficulty in taking the drink because his upper lip is pressed by the covering part. When he attempts to take the drink by applying his mouth to the opening part in such a state that his upper lip may lightly touch the covering part and avoid being pressed, he cannot manage to take the drink satisfactorily because the drink tends to overflow the gap between the mouth and the opening part of the bottle. When he elects to take the drink by wrapping his mouth wholly around the spout, he succeeds in preventing the drink from spilling at a sacrifice of the effect produced by the ventilating hole, with the result that the drink will produce an undulating motion in the neighborhood of the spout.

This invention has been initiated in the light of such a true state of affairs as mentioned above. It is aimed at providing a bottle spout that ensures a smooth outflow of the drink held in the bottle and befits the purpose of allowing a consumer to take the drink from the bottle by directly applying his mouth to the spout of the bottle.

It is another object of this invention to provide a bottle spout that, by virtue of a tilt of the bottle, enables the drink held in the bottle to be smoothly released without emitting an undulating motion to the exterior.

It is yet another object of this invention to provide a bottle spout that can be easily fitted to a ready-made bottle and enabled to have the drink in the bottle easily taken and decently swallowed and released smoothly.

### DISCLOSURE OF THE INVENTION

The present invention provides a spout of a bottle having a partition integrated therewith for dividing a space inside the spout into a liquid effluent part and an air influent part, which are opened toward an outer direction in an opening face of the spout, the partition having a part that extends on a side of the air influent part toward an interior of the bottle and is continued to an inner wall of the spout and closed in a bag form, and having in a trailing part thereof an air hole that connects the air influent part and the interior of the bottle.

The present invention further provides a spout of a bottle having a partition integrated therewith in an anterior part thereof for dividing a space inside the spout into a liquid effluent part and an air influent part, which are opened toward an outer direction in an opening face of the spout, the partition having a part that extends on a side of the air influent part toward an interior of the bottle and is continued to an inner wall of the spout and closed in a bag form, having in a trailing part thereof an air hole that connects the air influent part and the interior of the bottle and having in a posterior part thereof a mounting part that mounts the spout onto a spout of a ready-made bottle.

In the bottle spout, the partition has an anterior terminal face formed in a circular shape having a diameter smaller than that of the spout or in a shape having a central part thereof curved upwardly in a state wherein the air influent part falls above the liquid effluent part.

In the bottle spout, the partition has an anterior terminal face curved inwardly of the interior of the bottle.

When a user of a bottle provided with a spout of the construction described above applies his mouth to the opened terminal of the liquid effluent part of the bottle and tilts the bottle till the liquid effluent part falls below the air influent part, the drink in the bottle flows through the liquid effluent part into the user's mouth and the air flows into the space formed in the bottle via the air hole in the air influent part.

The drink is smoothly and continuously poured into the mouth because no collision occurs between the drink flowing out and the air flowing in as described above. Therefore, the user swallows the drink decently and contentedly without overflowing his mouth.

When the bottle provided with the spout of the construction described above is tilted till the liquid effluent part thereof reaches a low level as described above, the drink in the bottle is released through the liquid effluent part to the exterior and the space eventually formed inside the bottle admits the air via the air hole, with the result that the drink will be smoothly and continuously released without forming an undulating motion in the neighborhood of the spout.

Further, since the spout of the construction described above is provided in the posterior part thereof with a mounting part that is capable of easily mounting the spout of the aforementioned construction onto a spout of a ready-made bottle, the drinking water in the ready-made bottle can be likewise swallowed or discharged to the exterior without threatening any bounce thereof.

### BRIEF DESCRIPTION OF THE DRAWING

FIG. 1 is a perspective view illustrating the basic construction of a spout of a bottle according to this invention.

FIG. 2 is a front view of the spout of FIG. 1.

FIG. 3 is a cross section taken through FIG. 2 along line III-III.

FIG. 4 is a front view illustrating an example having a plurality of air holes disposed in the trailing terminal of a partition in the spout of a bottle according to this invention.

FIG. 5 is a front view illustrating an example having the partition of the spout of a bottle according to this invention formed in the upper part of the spout in a state wherein an air influent part thereof falls above a liquid effluent part thereof.

FIG. 6 is a front view of a spout of a bottle according to this invention, illustrating an example having provided therein a partition whose anterior face is formed in a curved shape.

FIG. 7 is a front view of a spout of a bottle according to this invention, illustrating an example having provided therein a partition whose anterior face is formed in a circular shape having a diameter smaller than that of the spout.

FIG. 8 is a cross section illustrating another example of the partition in a spout of a bottle according to this invention.

FIG. 9 is a perspective view illustrating yet another example of the partition in a spout of a bottle according to this invention.

FIG. 10 is a cross section illustrating one example of the state of having a spout of a bottle according to this invention mounted on a ready-made bottle.

FIG. 11 is a cross section illustrating another example of the state of having a spout of a bottle according to this invention mounted on a ready-made bottle.

### BEST MODE FOR CARRYING OUT THE INVENTION

This invention will be described in detail below with reference to the drawing attached hereto.

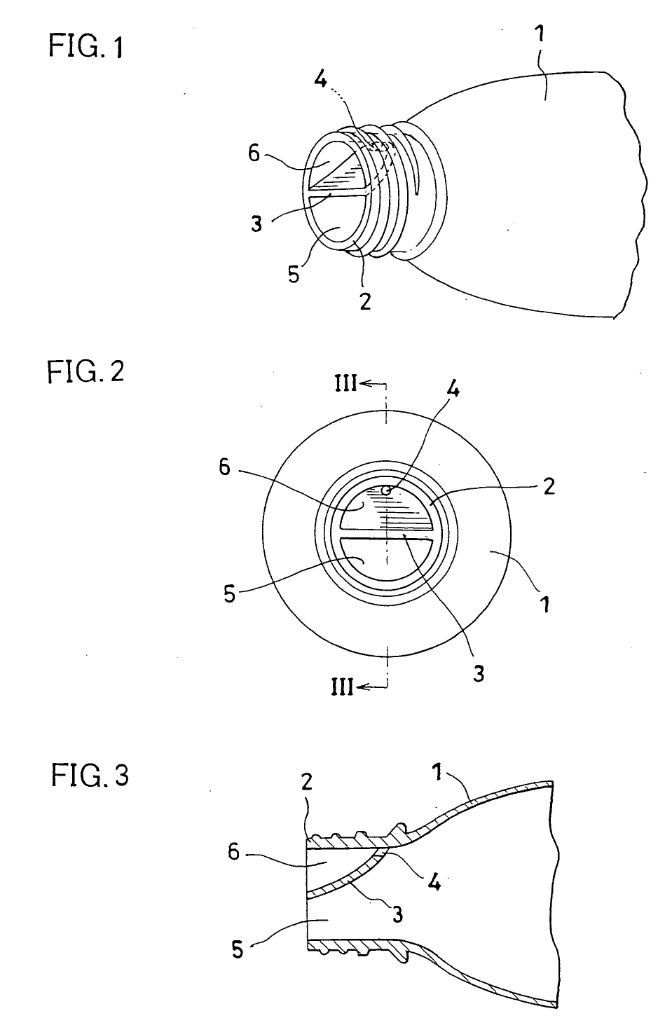

FIG. 1 is a perspective view illustrating the basic construction of a spout 2 of this invention integrated with a main body 1 of a bottle, FIG. 2 is a front view thereof, and FIG. 3 is a cross section taken through FIG. 2 along line III-III.

The spout 2 is provided with a partition 3 for dividing the space inside the spout into a liquid effluent part 5 and an air influent part 6, the partition being integrated with the spout, the liquid effluent part 5 side and the air influent part 6 side both being opened toward the outer direction in the opening face of the spout, the partition 3 being integrated with the inner wall of the spout 2 and closed on the air influent part 6 side in the form of a bag, and the partition 3 being provided in the trailing terminal thereof with an air hole 4 serving as a passage for advancing air from the air influent part 6 to the interior of the bottle.

When a person needs the drink in the bottle which is provided with the spout having the construction described above, he poses the bottle so as to place the liquid effluent part 5 on the lower side as illustrated in FIG. 1, applies his mouth to the opened terminal of the liquid effluent part 5 and tilts the bottle 1 and allows the drink in the bottle to flow through the liquid effluent part 5 into his mouth. As a result, the pressure inside the bottle becomes low as compared with the pressure outside the bottle and the air is caused to flow into the bottle through the air hole 4 in the air influent part 6. Thus, the drink is smoothly poured into the mouth continuously through the liquid effluent part and decently swallowed by the user because the drink flowing out of the bottle and the air flowing into the bottle do not collide.

Particularly, when the user wraps the fluid effluent part of the bottle with his mouth in such a manner that his upper lip may naturally enter the spout on the air influent part side, he can swallow the drink easily. For the purpose of releasing the liquid held in the bottle provided with the spout of the aforementioned construction, the user is required to tilt the bottle so that the air influent part may rise and the liquid effluent part may fall. Consequently, the liquid in the bottle starts toward the exterior of the bottle through the liquid effluent part and the space consequently formed in the bottle admits the air via the air hole disposed at the trailing terminal of the partition owing to the difference of air pressure. Thus, the liquid is smoothly and continuously released without producing an undulating motion in the neighborhood of the spout.

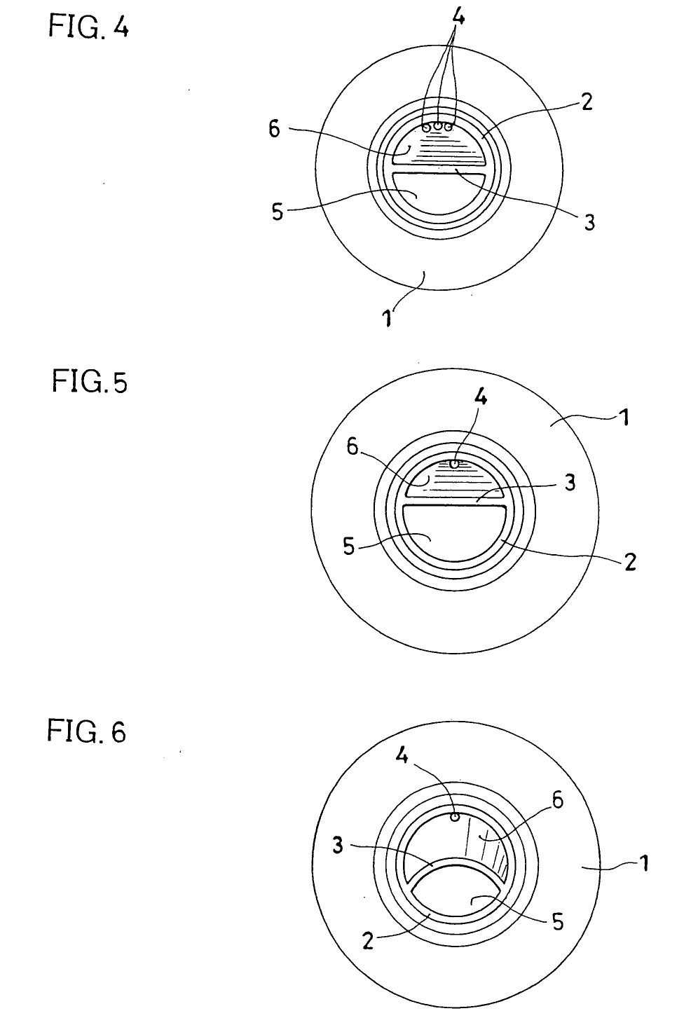

The shape and size of the liquid effluent part 5 of the spout described above and the position, size, shape and number of the air hole 4 may be freely decided, depending on the kind of the drinking water and the size and design of the spout. The shape of the air hole, for example, does not need to be restricted to a perfect circle but may be selected from among various shapes, such as ellipse, triangle, pentagram and heart to suit the purpose of use of the bottle or container. The number of air hole does not need to be limited to one. A plurality of air holes may be disposed to suit the purpose of use of the bottle as illustrated in FIG. 4. The air hole is preferred to be large for the purpose of enabling the user to swallow the drink in a large amount at a time. If the air hole is unduly large, however, the overage will possibly result in suffering the drink to spill through the air hole when the bottle is tilted. In this case, the provision of a plurality of small air holes 4 as illustrated in FIG. 4 serves the purpose of suppressing the leakage of the drink.

The position of the partition 3 disposed in the spout 2 of the bottle mentioned above is so selected as to intersect the center of the spout in the construction of FIG. 1. When this position is so selected as to fall upward from the center as illustrated in FIG. 5, the liquid effluent part 5 is allowed to occupy a large volume and assume a shape suitable for rapid swallow of the drink in a large amount. When the partition is positioned downward from the center conversely from the preceding case, the liquid effluent part 5 assumes a shape suitable for swallowing the drink in a small amount.

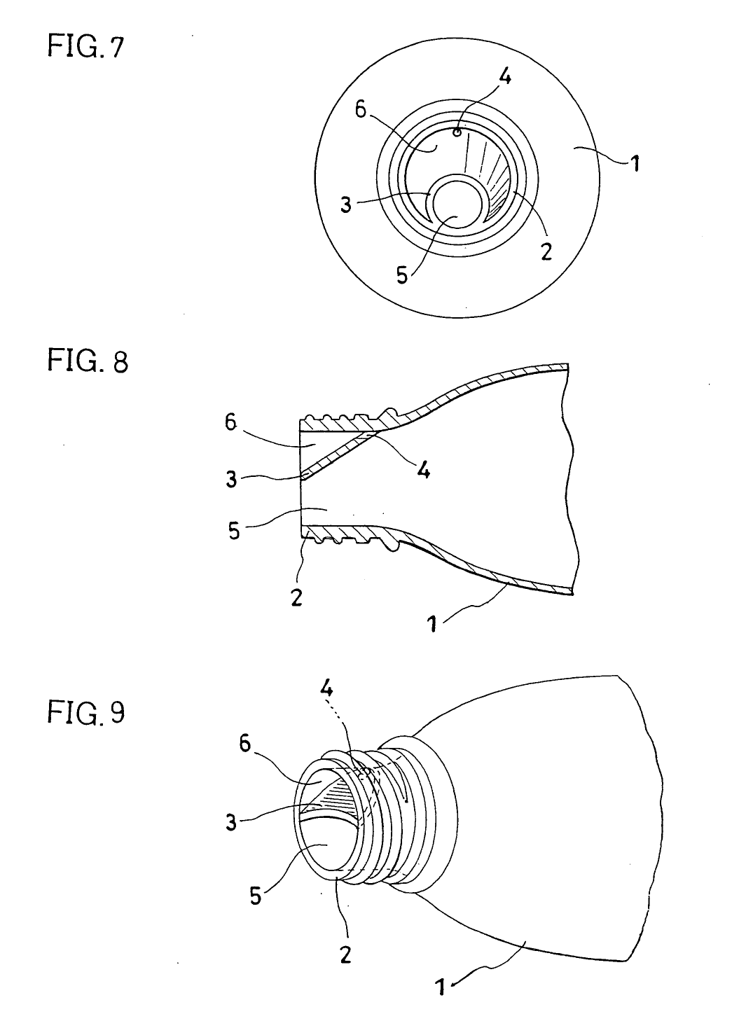

When the partition 3 is so shaped as to form an upwardly curved anterior terminal face as illustrated in FIG. 6, the liquid effluent part 5 assumes a shape resembling the shape of the user's mouth, allowing the liquid to gather copiously near the center of the liquid effluent part and enabling the user to swallow the drink in the bottle contentedly without spilling the drink.

Further, when the partition 3 is given the shape of a small circle as illustrated in FIG. 7, the liquid effluent part 5 fits easy wrap with the user's mouth, allows control of the amount of the drink to be released and permits even a female user or an infant user to take the drink without spilling it. Even in a vehicle in motion, this liquid effluent part 5 enables the user to swallow the drink similarly contentedly without spilling the drink.

The partition can adopt an optimum shape to suit the kind of the drink, the purpose of use and the kind of the user, for example.

The partition 3 has a curved cross section in the example illustrated in FIG. 3. It may have a planar cross section instead as illustrated in FIG. 8.

When the anterior terminal face of the partition 3 disposed in the spout which is touched by the user's mouth is given a shape dented and curved inwardly of the interior of the bottle, the user's upper lip fits in the dent and the opened terminal of the liquid effluent part is naturally covered wholly by the mouth so as to add further to the ease with which the drink inside the bottle is swallowed by the user.

The air hole 4 provided in the trailing terminal of the partition 3 may be produced in advance by piercing at the time of production of the bottle. For the purpose of preventing the drink leaking through the air influent part 6 during the transportation of the bottle, however, it may be formed by piercing at the time of removing the plug from the bottle. As a means to open the air hole 4 at the time of unplugging the bottle and using the drink therein, a method which comprises closing the part of the air hole 4 with a seal applied thereto on the air influent part 6 side and peeling this seal at the time the drink is used and a method which comprises forming the air hole 4 part in an easily cuttable contour in advance and clipping the air hole 4 part at the time of unplugging the bottle may be cited, for example.

The preceding examples invariably contemplate a spout of a bottle 1 which has a partition 3 directly formed in the spout of the bottle and has given rise to a liquid effluent part 5 and an air influent part 6.

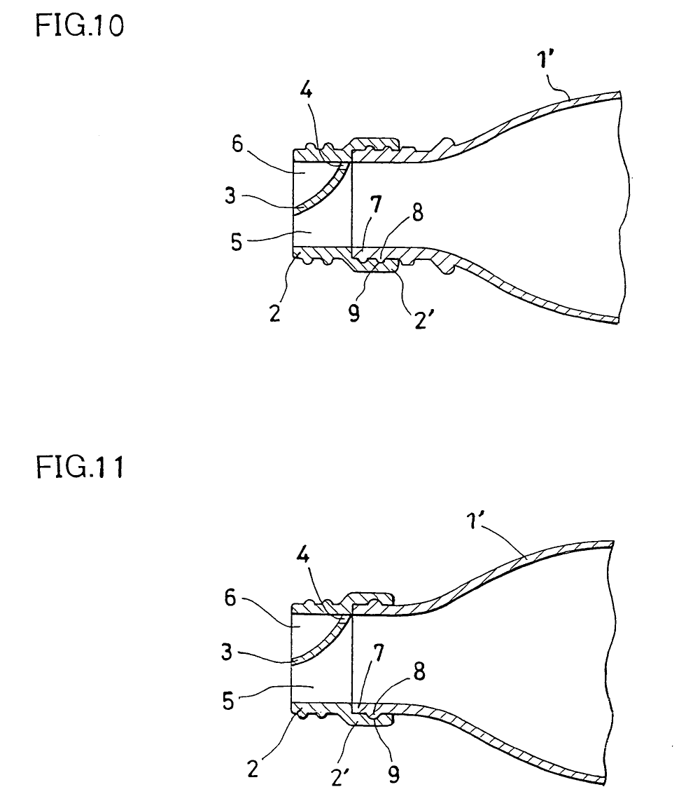

By providing in the anterior part a spout 2 of a bottle possessing a liquid effluent part 5 and an air influent part 6 by virtue of a partition 3 and providing in the posterior part a cylindrical part 2′, as a mounting part for a spout 7 of a ready-made bottle 1′, that has on an inner peripheral surface thereof a depressed groove 9 helically fitted to a threaded part 8 or mounted onto an annular projection 8 formed on the outer peripheral surface of the spout 7 of the ready-made bottle 1′ as illustrated in FIG. 10 and FIG. 11, however, it is made possible to mount the spout contemplated by this invention easily onto the spout of the ready-made bottle and utilize the two spouts so joined in the same manner as the spout of this invention integrated with the main body of a bottle. The resultant union enables the drink in the bottle to be swallowed satisfactorily by the user or the liquid in the bottle to be released smoothly to the exterior.

In the illustrated examples, the front face of the spout is depicted in a circular shape. The shape of the front face does not need to be restricted to such a circle but is only required to permit provision of a partition serving to divide the inner space of the spout into a fluid effluent part and an air influent part. Thus, the shape may be properly selected from among various shapes, such as ellipse, triangle, lemon and lips of a mouth, for example.

### INDUSTRIAL APPLICABILITY

The spout of this invention for a bottle has the open face thereof divided by a partition into a liquid effluent part and an air influent part as described above. When the bottle is tilted so as to raise the air influent part and lower the liquid effluent part, the drink in the bottle flows into the user's mouth through the liquid effluent part. The space formed inside the bottle immediately admits the air via the air hole formed in the air influent part. Since the pressure is constantly retained equally inside and outside the bottle, the drink is smoothly poured into the user's mouth continuously through the liquid effluent part without leaking through the gap between the mouth and the spout or producing an undulating motion in the neighborhood of the spout. The user is enabled to swallow the drink easily and decently.

The bottle that is provided with the spout of this invention has only to be tilted till the liquid effluent part is lowered in order that the liquid held therein may be smoothly released through the liquid effluent part. Thus, it can be utilized advantageously when the liquid is transferred from a large bottle into a small bottle, for example.

Further, the spout of this invention for a bottle embraces being provided with a mounting part that can be easily mounted onto a spout of a ready-made bottle. By mounting the spout of this invention onto the spout of the ready-made bottle, therefore, the user is enabled to swallow the drink in the bottle contentedly and release the liquid in the bottle smoothly to the exterior.

1-7. (canceled)

8. A spout of a bottle comprising:
a partition for dividing a space inside the spout into a liquid effluent part and an air influent part, which are opened toward an outer direction in an opening face of the spout, said partition including a part that extends on a side of the air influent part toward an interior of the bottle and is continued to an inner wall of the spout and closed in a bag form, and including in a trailing part thereof an air hole.

9. A spout of a bottle according to claim 8, wherein said partition includes an anterior terminal face formed in a shape having a central part thereof curved upwardly in a state wherein the air influent part falls above the liquid effluent part.

10. A spout of a bottle according to claim 8, wherein said partition includes an anterior terminal face formed in a circular shape having a diameter smaller than that of the spout.

11. A spout for a bottle according to claim 8, wherein said partition includes an anterior terminal face curved inwardly of the interior of the bottle.

12. A spout for a bottle according to claim 8, wherein said partition is provided in a trailing terminal of the spout with a plurality of air holes.

13. A spout of a bottle comprising:
a partition in an anterior part of the spout for dividing a space inside the spout into a liquid effluent part and an air influent part, which are opened toward an outer direction in an opening face of the spout, the partition including a part that extends on a side of the air influent part toward an interior of the bottle and is continued to an inner wall of the spout and closed in a bag form, including in a trailing part thereof with an air hole and including in a posterior part thereof a mounting part that mounts the spout onto a spout of a ready-made bottle.

14. A spout of a bottle according to claim 13, wherein said partition includes an anterior terminal face formed in a shape having a central part thereof curved upwardly in a state wherein the air influent part falls above the liquid effluent part.

15. A spout of a bottle according to claim 13, wherein said partition includes an anterior terminal face formed in a circular shape having a diameter smaller than that of the spout.

16. A spout for a bottle according to claim 13, wherein said partition includes an anterior terminal face curved inwardly of the interior of the bottle.

17. A spout for a bottle according to claim 13, wherein said partition is provided in a trailing terminal of the spout with a plurality of air holes.

18. A spout for a bottle according to claim 13, wherein said mounting part is a cylindrical part that is furnished on an inner peripheral surface disposed so as to continue into a trailing part of said spout with a depressed groove helically fitted to a threaded part or mounted onto an annular projection disposed on an outer peripheral surface of a spout of a ready-made bottom.
